(19) United States
(12) Patent Application Publication
(10) Pub. No.: US 2012/0145688 A1
(43) Pub. Date: Jun. 14, 2012

(54) System and method for monitoring and recording welder information

(76) Inventors: John H. Moon, JR., Bixby, OK (US); Wallace E. Lively, South Point, OH (US)

(21) Appl. No.: 12/928,514

(22) Filed: Dec. 13, 2010

(51) Int. Cl. B23K 9/10

(52) U.S. Cl. 219/130.01; 219/137 R

(57) ABSTRACT

A weld monitoring and recording system and method monitors an ongoing welding operation and compares the welding current, the welding voltage, pre-heat/inter-pass temperature or other parameters from a previously qualified weld that are stored within a programmable device or computer. If the monitored parameters vary from the qualified parameters, then the weld is automatically interrupted until the operating parameters once again match the stored qualified parameters. A recorder can record different values related to the ongoing welding operation in order to provide documentation about the weld that can be viewed, printed, or downloaded.

### FIELD OF THE INVENTION

The present invention relates to welders and more particularly to controlling a manual welder.

### BACKGROUND OF THE INVENTION

One area of welding that is of particular commercial value is shielded metal arc welding (SMAW) involving field welding of pipe that contain fluids, gases or solids that are considered code work by one or more different entities such as a facilities owner, the Department of Transportation, Federal Energy Regulatory Commission, public service commissions and the like. These pipe and pipeline welds are typically made using the SMAW process utilizing portable welding rigs. The nature of this work requires welders to be separated by various distances. In many cases, the distances can encompass many miles and involve the need to move to new weld locations frequently during a work day. As a result, it is difficult if not impossible to monitor the welding operation, particularly continuous monitoring of the welding operation.

Presently, welds of this nature are inspected visually, after completion, and also non-destructively tested, after completion. The non-destructive tests, for example can involve radiographic testing, ultrasonic testing, magnetic particle testing, dye-penetrant testing, and similar methods. Although these testing methods are the currently accepted industry standards for evaluating a completed weld, they are time consuming, generate bulky or difficult-to-keep records, and slow the welding operations significantly.

Thus, there remains a need for a system and method for monitoring welding operations of these portable welding rigs that simply and easily ensures all welds are accomplished within accepted parameters so as to result in an acceptable weld.

### SUMMARY OF THE INVENTION

In accordance with a preferred embodiment, a weld monitoring and recording system and method monitors an ongoing welding operation and compares the welding current, the welding voltage, weld pre-heat and other parameters from a previously qualified weld that are stored within a programmable device or computer. If the monitored parameters vary from the qualified parameters, then the weld is automatically interrupted until the operating parameters once again match the stored qualified parameters. A recorder can record different values related to the ongoing welding operation in order to provide documentation about the weld that can be viewed, printed, or downloaded.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 is a conceptual drawing of a welder monitoring and recording system in accordance with the principles of the present invention.

FIG. 2 is a flowchart of an exemplary method of monitoring welder operation in accordance with the principles of the present invention.

### DETAILED DESCRIPTION OF THE PREFERRED EMBODIMENTS

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Some of the example welding procedures described below happen to involve SMAW welding but embodiments of the present invention are not limited to this type of welding. Other types of similar welding procedures are contemplated within the scope of the present invention. Additionally, some embodiments of the present invention relate to a portable welding rig such as the ones usually used on pipeline welding. However, other manual type welding devices are also contemplated within the scope of the present invention. Such manual welding operations are significantly different than computer-controlled, automatic welding operations where a computer applies the correct parameters while performing welding operations based on programmed instructions. In contrast, the welding operations considered herein are manual ones in which the variance in ambient environment and the differences in welding skills and techniques of the welders have to be accounted for when ensuring the quality of the welds.

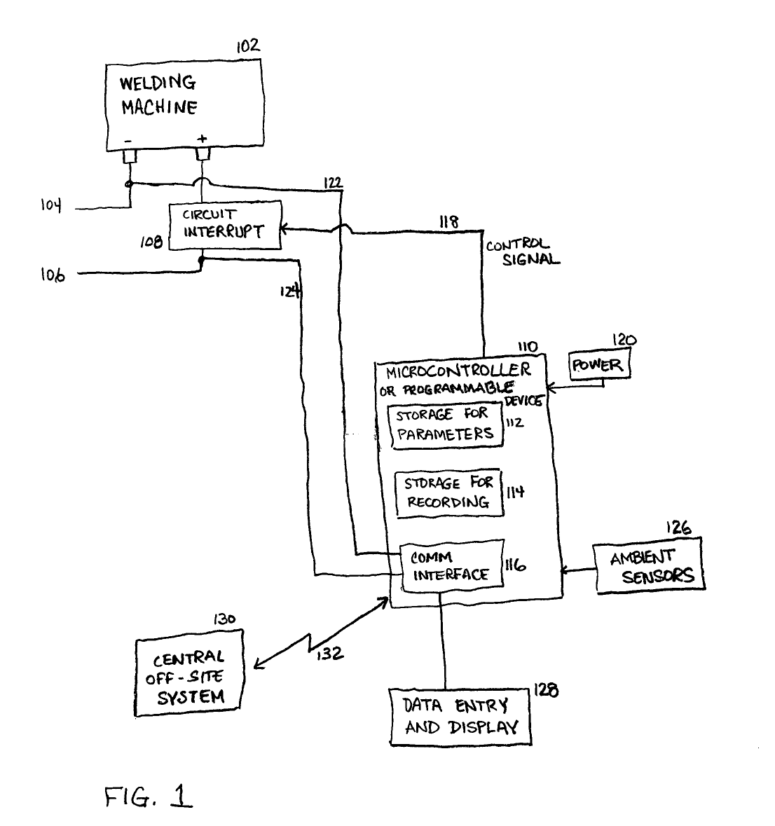

FIG. 1 is a conceptual drawing of a welder monitoring and recording system in accordance with the principles of the present invention. A manual welding machine 102, such as for example a portable welding rig, is depicted that has leads 104, 106 coming from respective terminals. The leads 104, 106 are used by a welder to perform welding operations as desired. The negative lead 104 and the positive lead 106 are also connected to a programmable device 110. The illustration of FIG. 1 shows the leads 104, 106 being tapped outside of the welding machine 102 but this is simply one of many ways to accomplish providing the appropriate signals to the programmable device 110. One of ordinary skill will recognize that the positive and negative terminals within the welding machine 102 can be connected to wires that are then coupled to the programmable device 110. Alternatively, to accommodate some environments, the data related to the leads 104, 106 may be wirelessly communicated to the programmable device 110. Infrared connections, Bluetooth communications, cellular communications, and other radio-frequency communication methods could be used with the appropriate transceivers in order for the welding machine 102 and the programmable device 110 to exchange data. It is beneficial to have the programmable device 110 have the signal acquisition, signal filtering and signal measuring circuits to accommodate the signals 122, 124 from the terminals 104, 106 because that would require no modification to the welding machine 102. However, it can be appreciated that such signal processing functions could be accomplished by additional circuitry within the welding machine 102 and then signals representative of the values at the terminals 104, 106 could be communicated with the programmable device 110.

The programmable device may, for example, be a programmable computer having a processor, memory, permanent storage, removable storage media, etc. as is typical. As such, the programmable computer will include a program of instructions (stored on a computer readable storage medium) that when executed transforms the computer into a specialized machine for performing the functions of monitoring a welding operation as described in more detail herein. However, the programmable device 110 may also be specialized hardware designed around a microcontroller to perform substantially the functionality of the welding monitor device described in detail herein.

The programmable device 110 includes a storage 112 that is configured to store welding parameters and there is also storage 114 for recording ongoing welding operations. These separate storage partitions can be separate storage devices or can be logical partitions of one physical storage device as well. A communications interface 116 is included as well. The communications interface 116 is configured to accommodate whatever signals are being anticipated to be received by the programmable device 110 and what signals it is anticipated to generate.

The programmable device 110, for example, receives information about the state of the welding machine 102 over communication paths 122 and 124. Information from optional ambient sensors 126 are also received and additional data is received through a user interface 128. The power 120 can be provided from any of a number of sources such as a battery, a conventional electrical circuit, a vehicle's power system, or from a tap off the welding machine 102. As for outputs, the programmable device 110 can provide a control signal 118 to a circuit interrupt 108 and can provide data for display on the user interface 128. The user interface 128 can include display screens, keypads, keyboards, and other communications interfaces that allow data to be exchanged with the programmable device 110. The programmable device 110 can also include removable storage such as memory cards, disks, optical disks, etc. and can also be linked with a central, off-site system 130 as well. A communications channel 132 can be used to offload data from the storage partitions 112, 114 to a computer physically present nearby or by radio, or other network, to a physically distant computer. In this way, the information within the programmable device can be stored and archived for future reference.

The circuit interrupt 108 is an optional device that interrupts the current that is being fed to the positive lead 106. One of ordinary skill will recognize that the circuit interrupt 108 can be positioned in a number of different locations without departing from the scope of the present invention. The important function is that through the use of this circuit interrupt 108, welding operations are caused to cease. Such interruption can be achieved using a relay, a solid-state switch or similar devices; one of ordinary skill will appreciate that there are many different functionally equivalent techniques for interrupting current flow in an electrical circuit. As mentioned briefly above, the circuit interrupt 108 is controlled via a control signal 118 received from the programmable device 110. One preferable arrangement of the programmable device 110 and the circuit interrupt 108 is that when the programmable device is in a quiescent state such as not powered, turned off, or disconnected, then the circuit interrupt 108 is configured to not interrupt the current on the positive lead 106. In other words, current is interrupted only when the programmable device actively sends a control signal 118 that causes the circuit interrupt 108 to open the circuit.

Through the communications links 122 and 124, the programmable device can receive an indication of the voltage and current presently applied to the leads 104, 106 during a welding operation. As the welder manually completes the weld, these parameters will fluctuate and such fluctuations are detected and monitored. Additionally, internal timer circuits can be utilized to determine a weld time for each welding operation. Through the user interface 128 a welder can enter such information as a welder identification, an identification of a current welding operation, a welding location, different welding parameters, number of electrodes used during a welding operation, the electrode size (e.g., diameter), etc. Time, date, temperature and similar external data can be provided using the user interface 128 or from one or more ambient sensors 126. One of ordinary skill will recognize that more or less information can be recorded and stored than the examples identified above without departing from the scope of the present invention.

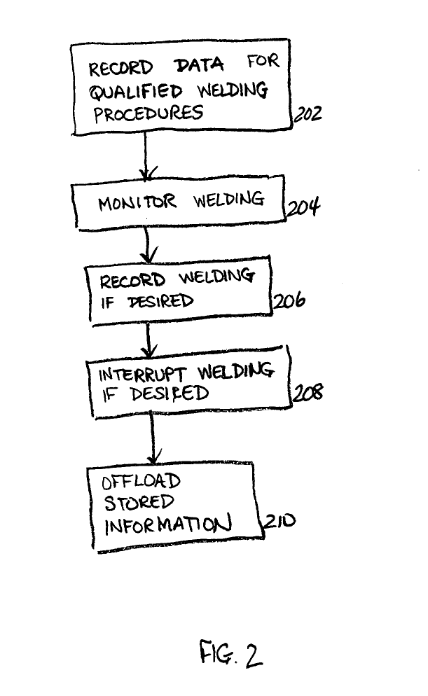

FIG. 2 is a flowchart of an exemplary method of monitoring welder operation in accordance with the principles of the present invention. In step 202, the system of FIG. 1 can be utilized to record data of qualified welding procedures. For example, a welding operation depends on the type of material being welded, the size of the material being welded, the material of the electrode, ambient conditions, and other variable environmental parameters. Within these constraints, there is a range of current, voltage, pre-heat/inter-pass temperature, and welding speed that will typically produce a quality weld that meets all requirements for a particular job.

To begin, information such as a welding designation (e.g., a location, a pipeline name, a job-site name, etc.), a welder's identification (e.g., name, initials, union number, etc.), time, date, ambient temperature, pre-heat/inter-pass temperature, electrode information, etc. can be entered or detected. The programmable device 110 can then be placed in a “record” mode such that parameters such as current, voltage, and elapsed weld time from the welding machine 102 can be detected by the programmable device 110 and stored in memory such as storage 114. Once the welding operation is complete, the weld can be destructively tested or non-destructively tested to determine if a proper weld, or qualified weld, was accomplished. If a proper weld of sufficient quality was not accomplished, then the storage 114 can be cleared and the process repeated. Once a qualified weld is produced, then the stored parameters can be used to represent the operating conditions for a welding machine to reproduce a proper, quality weld under similar conditions. The stored parameters for voltage, current, weld time, etc. are specific values but can be considered as representative of the range of acceptable values. Thus, the stored value +/−10% may be acceptable operating parameters for producing qualified welds.

Once a weld is qualified, then the stored parameters can be viewed, downloaded, printed, or otherwise exchanged so that other welders can know what operating parameters are acceptable for the expected conditions. In one alternative, the parameters can be communicated by a wireless interface to a plurality of different welders so that at a job site the different welding machines can automatically receive, and be programmed with, the proper operating parameters.

Thus, in step 204 there is a mode for the programmable device 110 to monitor welding operations and optionally record them in step 206. In this mode, a welder can use the user interface 128 to input information such as their identity, the designation for the weld about to take place, the date, the time, and the welding parameters. As discussed above, some of this information can be automatically uploaded as well and would not require the welder to manually enter it. In one embodiment, there may be a minimal set of information that must be entered before the programmable device 110 operates. For example, if the programmable device does not have the weld designation, the current parameter, and the voltage parameter, pre-heat/interpass temperature, then it will not operate so as to monitor and record information. One of ordinary skill will recognize that the specific data within this minimal set of data may vary and whether or not this functionality is implemented may vary without departing from the scope of the present invention.

Once the programmable device 110 is operational it can record the information about a welding operation in real-time if desired. The precision with which the welding operations are monitored can be a programmable setting of the programmable device 110 depending on the requirements for each welding operation. For example, current and/or voltage can have transient spikes that need not be recorded. Thus, the values recorded by the programmable device can be a moving average such as a moving average of a time period spanning three seconds and sampled every half-second. Other statistical smoothing functions are contemplated as well without departing from the scope of the present invention, as well as different sample rates. As mentioned, these settings about how the samples are obtained and processed can be selectively programmed in the programmable device 110 using the user interface 128 or from an external communications link.

In addition to monitoring and recording the welding operating parameters, the user interface 128 can be used to input information such as the welding rod diameter, the amount of rods used, feed rate and other information that is desirable to record regarding the welding operation. At the end of the welding operation, there is now a recorded history of that weld and the parameters which accompanied carrying out that welding operation. Thus, it provides documentation of the weld and how it was performed.

Another use for the monitoring and recording of the welding operation is to optionally control the circuit interrupt 108 as depicted in step 208 of FIG. 2. In this step, the programmable device can compare the ongoing welding operation with the qualified welding parameters for a given weld operation. A number of different types of analog or digital comparator circuits can be used to perform the comparison between the signals for the ongoing welding operation with the stored qualified parameters. The current of the welding machine, the voltage of the welding machine, or both can be monitored and compared during an ongoing welding operation so that if any of those values diverge from the acceptable parameters, then the arc to the weld can be interrupted. When operating parameters of the welding machine return to the acceptable range of parameters, then welding is permitted to continue. In this way, at the completion of a welding operation, there is a verifiable record that the weld was performed within the acceptable parameters of the qualified weld previously determined. Thus, there would be no requirement to record periodic values for the welding operations because the inclusion of the circuit interrupt necessarily ensures that all welding occurred within the qualified parameters.

As mentioned above, the raw sampled parameters from the welding machine can be statistically smoothed (e.g., a moving average) to account for transient spikes and troughs within the signals. Similarly, the qualified parameters are considered as an acceptable range of values rather than an exact value. The amount of allowed variance can be a programmable setting of the programmable device 110 such that the device 110 can be set to interrupt the arc only if a parameter is more than 1% (or 5%, or 10%) divergent from the qualified parameter.

Because welding in some environments is not an exact science under all circumstances, there may be times where the weld operation must be performed outside of the qualified parameters. In this instance, the welder can use the user interface 128 to temporarily suspend monitoring of the welding operation but such an occurrence is stored in the programmable device 110 so that such a weld is identified as a potential issue and other inspection techniques can be used to analyze that weld.

Because of the wide variety of information that can be stored in the programmable device 110 a record can be created for each weld that identifies the weld designation, the operating parameters, the time, the date, the welder, the welding rods used, the ambient temperature, pre-heat/inter-pass temperature, any welds where monitoring was suspended, the welding machine, the weld time, etc. This information can be used to document when and how a welding operation transpired for any of a number of entities that might be interested in such information. As such, the programmable device 110 and the user interface 128 can work together to download the stored information to a handheld computer, a removable storage device, a nearby-wirelessly-connected computer, or a central off-site system through the Internet or similar network.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein; but are to be accorded the full scope consistent with each claim's language, wherein reference to an element in the singular is not intended to mean “one and only one” unless specifically so stated but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A system comprising:
a manual welding machine having a positive terminal and a negative terminal;
a programmable computer having a first input coupled with the positive terminal, a second input coupled with the negative terminal, and an output;
a first memory configured to store qualified parameters for a weld operation;
a circuit configured to interrupt an operating current of the welding machine when the circuit is in a first state and to not-interrupt the operating current of the welding machine when the circuit is in a second state, the circuit coupled with the output of the programmable computer; and
the programmable computer includes a comparator configured to compare signals from the first and second input to the qualified parameters and to generate an output signal at the output that causes the circuit to change from the second state to the first state if the signals from the first and second input are different than the qualified parameters.

2. The system of claim 1, wherein the qualified parameters include a welding current.

3. The system of claim 1, wherein the qualified parameters include a welding voltage.

4. The system of claim 1, wherein the qualified parameters include a welding current and a welding voltage.

5. The system of claim 1, wherein the signals from the first and second input are different than the qualified parameters when the signals differ by at least 10% from the qualified parameters.

6. The system of claim 1, wherein the signals from the first and second input are different than the qualified parameters when the signals differ by at least 1% from the qualified parameters.

7. The system of claim 1, further comprising:
a second memory configured to store at least one of ambient temperature, pre-heat/inter-pass temperature, weld designation, welder identity, rod size, a number of rods used during a weld, welding procedure designation, and weld time.

8. The system of claim 7, further comprising:
an interface coupled with the programmable computer configured to disable the output signal for a welding operation; and
wherein occurrence of disabling the output signal is recorded in the second memory.

9. The system of claim 1, wherein:
the comparator is further configured to change the output signal that causes the circuit to change from the first state to the second state when the signals from the first and second input are substantially the same as the qualified parameters.

10. The system of claim 1, further comprising:
an interface configured to read data from and to store into the first memory.

11. A method for monitoring a welding machine used in a manual welding operation including:
acquiring at least one signal representing operating parameters of the welding machine;
comparing the at least one signal with a qualified operating parameter previously determined for the manual welding operation; and
interrupting the manual welding operation if the at least one signal is not substantially the same as the qualified operating parameter.

12. The method of claim 11, further comprising:
resuming the manual welding operation when the at least one signal is substantially the same as the qualified operating parameter.

13. The method of claim 11, wherein the at least one signal represents a welding current or a welding voltage.

14. The method of claim 11, wherein the at least one signal includes a first signal representing a welding current and a second signal representing a welding voltage and the qualified operating parameter includes a qualified current value and a qualified voltage value.

15. The method of claim 11, wherein interrupting the manual welding operation includes generating an output signal configured to interrupt an arc of the welding machine.

16. The method of claim 11, further comprising:
receiving the qualified operating parameter; and
storing the qualified operating parameter.

17. The method of claim 16, further comprising:
storing at least one of ambient temperature, pre-heat/inter-pass temperature, weld designation, welder identity, rod size, a number of rods used during a weld, welding procedure designation, and weld time.

18. A method of establishing qualified welding operating parameters including:
performing a manual weld operation with a welding machine to create a weld;
recording at least one signal representing operating parameters of the welding machine;
destructively testing the weld to determine that the weld is a qualified weld; and
storing a value for the at least one signal as a qualified operating parameter.

19. The method of claim 18, wherein the at least one signal includes a first signal representing a welding current and a second signal representing a welding voltage and the qualified operating parameter includes a qualified current value and a qualified voltage value.

20. The method of claim 18, further comprising:
distributing the qualified operating parameter to a plurality of different welding machines.
